(19) United States
(12) Patent Application Publication
(10) Pub. No.: US 2025/0062787 A1
(43) Pub. Date: Feb. 20, 2025

(54) RADIO FREQUENCY COMMUNICATION DEVICE

(71) Applicant: STMICROELECTRONICS INTERNATIONAL N.V., Geneva (CH)

(72) Inventor: Jean-Pierre LAGARDE, laval en belledonne (FR)

(21) Appl. No.: 18/792,745

(22) Filed: Aug. 2, 2024

(30) Foreign Application Priority Data
Aug. 16, 2023 (FR) 2308725

(51) Int. Cl. H04B 1/40; H04B 1/00; H04L 7/00

(52) U.S. Cl. CPC H04B 1/40; H04B 1/0003; H04L 7/0008

(57) ABSTRACT

Apparatuses, systems, and methods for radio frequency communication circuit are provided. For example, a radio frequency communication device includes a clock signal generator configured to deliver a clock signal, based on a time base common to a communication mode and to a standby mode, from a first reference signal and a second reference signal.

### CROSS REFERENCE TO RELATED APPLICATIONS

This application claims the priority benefit of French patent application number FR2308725, filed on Aug. 16, 2023, and entitled “Dispositif de communication radiofréquence,” which is hereby incorporated by reference to the maximum extent allowable by law.

### TECHNICAL FIELD

The present disclosure generally concerns radio frequency communication devices and particularly radio frequency communication devices of BLUETOOTH® type.

### BACKGROUND

Many radio frequency communication devices operate according to the BLUETOOTH®, BLUETOOTH® LOW ENERGY, or also IEEE 802.15.4 protocols. These protocols require a plurality of clock signals having different accuracies according to the operating mode, for example, communication or standby.

Current devices use complex embedded software to implement the use of the different clock signals. This is costly in terms of development costs but also of production costs and results in a non-negligible power consumption.

### BRIEF SUMMARY

There exists a need to improve current radio frequency communication devices.

An embodiment overcomes all or part of the disadvantages of known radio frequency communication devices.

An embodiment provides a radio frequency communication device comprising a clock signal generator configured to deliver a clock signal, based on a time base common to a communication mode and to a standby mode, based on a first reference signal and on a second reference signal.

According to an embodiment, the clock signal generator comprises an accumulator circuit configured to:
in the communication mode, be driven by a communication mode clock signal originating from the second reference signal, and be incremented according to a parameter of the communication mode; and
in the standby mode, be driven by a standby mode clock signal originating from the first reference signal, and be incremented according to a parameter of the standby mode.

According to an embodiment, the clock signal generator comprises a calibration circuit configured to output a number of periods of the second reference signal for a given number of periods of the first reference signal;

the output of the calibration circuit providing a possible value of the parameter of the standby mode.

According to an embodiment, the accumulator circuit comprises a modulo function calculation circuit and a register, the modulo function calculation circuit being configured to implement a modulo function between a current value of the register and a comparison parameter associated with the given number of periods of the first reference signal, the register being configured to:
in the communication mode, be driven by the communication mode clock signal and receive as an input the parameter of the communication mode to which is added an output result of the modulo function calculation circuit; and
in the standby mode, be driven by a standby mode clock signal proportional to the first reference signal, and receive as an input the parameter of the standby mode to which is added the output result of the modulo function calculation circuit.

According to an embodiment, the accumulator circuit comprises a counter configured to:
in the communication mode, be driven by the communication mode clock signal and by a control signal depending on a comparison between the current value of the register and of the comparison parameter; and
in the standby mode, be driven by the standby mode clock signal and by the control signal.

According to an embodiment, the counter is configured to increment when the current value of the register is greater than the comparison parameter.

According to an embodiment, the accumulator comprises a wrap-around counter configured to be set back to zero when it reaches a value equal to the ratio of a frequency of the communication mode clock signal to the frequency of the clock signal to be obtained.

According to an embodiment, the counter comprises a shift register.

According to an embodiment, the value of the parameter of the communication mode and/or of the parameter of the standby mode is imposed.

According to an embodiment, the parameter of the communication mode is imposed at zero during a transition between the standby mode and the communication mode.

According to an embodiment, the parameter of the communication mode is imposed, in the communication mode, at the value of the comparison parameter divided by the ratio of the frequency of the communication mode clock signal to the frequency of the clock signal to be obtained.

According to an embodiment, the parameter of the standby mode is imposed at an initial value equal to 1,000 times the number of periods of the first reference signal.

According to an embodiment, the standby mode clock signal has a frequency equal to twice the frequency of the first reference signal.

According to an embodiment, the frequency of the clock signal to be obtained is 32 kHz, the frequency of the communication mode clock signal is 4 MHZ, and the frequency of the second reference signal is 32 MHz, and the frequency of the first reference signal is in the range from 16 to 60 kHz.

According to an embodiment, the comparison parameter is equal to 2,000 times the number of periods of the first reference signal, and the number of periods of the first reference signal is selected between 32, 64, and 128.

According to an embodiment, the values of the counter and those of the register respectively provide the integer part and the decimal part of the time base.

According to an embodiment, the first and second reference signals have different frequency accuracies.

According to an embodiment, the device is of BLUETOOTH®, BLUETOOTH® LOW ENERGY, or IEEE 802.15.4 type.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 shows an example of architecture of a radio frequency communication device;

FIG. 2 shows a radio frequency communication device according to an embodiment;

FIG. 3 shows a timing diagram of an operating mode of the radio frequency communication device of FIG. 2;

FIG. 4 shows a timing diagram of another operating mode of the radio frequency communication device of FIG. 2;

FIG. 5 shows a summary table of an operating mode of the radio frequency communication device of FIG. 2; and

FIG. 6 shows a summary table of another operating mode of the radio frequency communication device of FIG. 2.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “edge”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

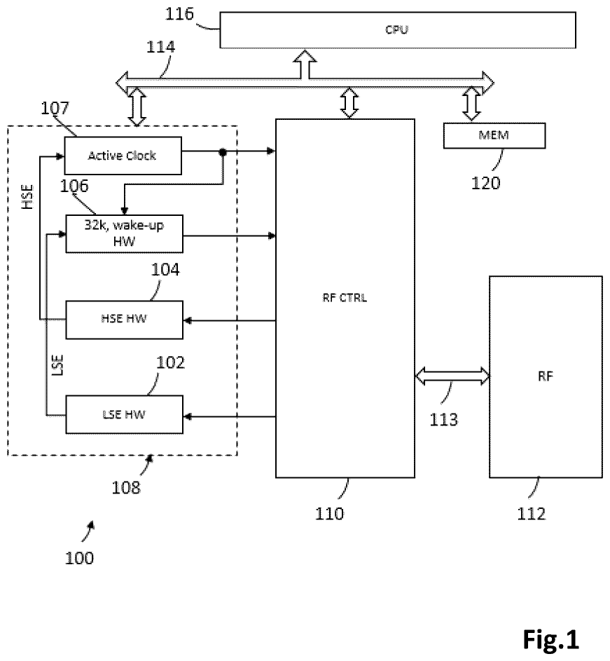

FIG. 1 shows an example of architecture of a radio frequency communication device 100.

Device 100 comprises a radio frequency transceiver circuit 112 (RF) comprising for example an antenna and for example an impedance matching circuit. Circuit 112 is coupled, preferably connected, via for example a bus 113, to a radio frequency controller 110 (RF CTRL) implementing the radio frequency communication protocol of device 100. Device 100 for example further comprises a central processing unit 116 (CPU) comprising one or a plurality of processors under control of instructions stored in a system instruction memory, not shown. Device 100 for example comprises one or a plurality of volatile or non-volatile memories 120 (MEM). Device 100 for example further comprises a set 108 of blocks 102 (LSE HW), 104 (HSE HW), 106 (32 k, wake-up HW), and 107 (Active Clock) for generating different clock signals. Block 102 is configured to deliver a clock reference signal, for example by means of a crystal oscillator. The clock signal supplied by block 102 is for example centered on 32.768 kHz.

Block 104 is configured to deliver another reference clock signal, for example by means of another crystal oscillator. The clock signal delivered by block 104 is for example at 32 MHz. Block 107 is configured to deliver a clock signal, for example by means of the clock signal delivered by block 104. In an example, the frequency of the clock signal delivered by block 107 results from a division of the frequency of the signal issued by block 104. When the clock frequency desired to power controller 110 is for example at 32 kHz, the frequency issued by block 104 is for example 32 MHz and at the output of block 107 for example of 4 MHZ.

In an example, block 106 receives as an input the signal issued by block 107 as well as the signal issued by block 102. Other clock signals (LSI), not shown in FIG. 1, for example issued by an internal oscillator (RCO32k), may also be used by block 106. Block 106 is for example configured to wake up device 100 according to anticipated or programmed events.

Controller 116, volatile or non-volatile memories 120 (MEM), block 108, and radio frequency controller 110 may exchange, via one or a plurality of system buses 114, data, addresses, and control signals for example.

Device 100 may further integrate other circuits implementing other functions (for example, one or a plurality of volatile and/or non-volatile memories, other processing units), not shown in FIG. 1.

Device 100 is for example of BLUETOOTH®, BLUETOOTH® LOW ENERGY, or IEEE 802.15.4 type. These protocols for example define timed events according to a standby mode and to a communication mode. In the standby mode, the device for example periodically wakes up to verify whether another device is nearby. In the communication mode, the device communicates with another nearby device. In the case of BLUETOOTH® LOW ENERGY for example, the evets are defined with a 0.625-ms resolution. This protocol further provides for the timing of events to be performed with a clock signal which has an accuracy of 500 ppm in the standby mode and of 40 ppm in the communication mode. This is usually achieved by means of clock signals issued by different crystal oscillators such as for example the signals issued by blocks 102 and 104.

To be usable by block 110, the clock signals for example require a calibration. This calibration is implemented to occur periodically or at the beginning of the communication mode for example. However, this calibration is often intrusive and requires software resources which adversely affect the power efficiency of the device.

Further, the use of different clock signals based on different crystals for the different modes of device 100 implies the implementation of a plurality of time bases. Complex software resources are then necessary to enable to use these different time bases. This impacts the complexity of implementation, the production costs, as well as the energy performance of device 100.

The described embodiments provide for the radio frequency communication device to comprise a clock signal generator configured to deliver a clock signal, based on a time base common to the communication mode and to the standby mode, from a first reference signal and a second reference signal.

This enables to obtain a single time base for the standby and communication modes as well as to decrease the power consumption by decreasing the use of software solutions, for example.

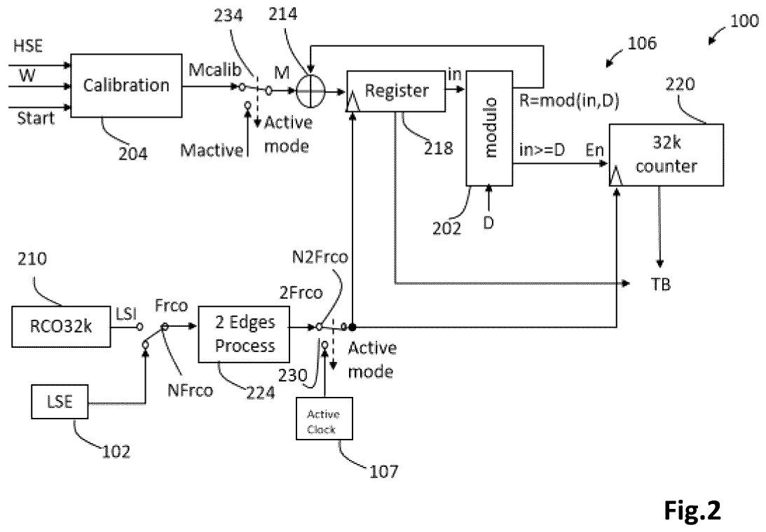

FIG. 2 shows radio frequency communication device 100 according to an embodiment. More particularly, FIG. 2 shows the architecture of block 106.

In the shown example, block 106 comprises a node NFrco coupling block 102, or for example another block 210 (RCO32k) for delivering a clock signal (LSI) in parameterizable fashion, to a block 224 (2 Edges Process). Block 224 receives the signal issued by blocks 102 or 210 and having its main frequency noted Frco, then doubles this frequency, which provides at an output node N2Frco of block 224 a frequency noted 2Frco. Block 224 is for example contained in block 106. Node N2Frco is coupled, preferably connected, to a clock input of a register 218 (Register) as well as to a clock input of a counter 220 (32k counter) via a dual-path switch 230. Switch 230 is configured to couple, in standby mode, the clock input of block 224 to register 218 and to counter 220 and, in the communication mode, block 107 to the clock input of register 218 and to the clock input of counter 220. Switch 230 is for example controlled by block 110.

Counter 220 for example has a size from 12 to 29 bits, for example 22 bits, which covers a period called “advertising” of the BLUETOOTH® LOW ENERGY protocol having a duration of 128 seconds.

In an example, counter 220 and/or register 218 form a wrap-around accumulator configured to be set back to zero when the counter reaches a value equal to the ratio of a frequency of the communication mode clock signal (Active clock) to the frequency of the clock signal to be obtained.

In the shown example, block 106 further comprises a calibration unit 204 (Calibration) taking as an input the clock signal (HSE) issued by block 104, as well as a parameter (W) which corresponds to a given number of periods of the signal (LSE, LSI) issued by blocks 102 or 210. Calibration unit 204 for example starts when it receives a start signal (Start). Calibration unit 204 is for example configured to output a standby mode parameter (Mcalib), which corresponds to a number of periods of the signal (HSE) issued by block 104 during the number W of periods of the signal issued by block 102 or 210 (LSE, LSI).

In the shown example, register 218 has an output coupled, preferably connected, to a modulo function calculation circuit 202 (modulo). Modulo function calculation circuit 202 is configured to deliver on an output the result (R) of a modulo function between a current value (in) of the register and a comparison parameter (D) associated with number W. The modulo operation is a binary operation which associates with two natural integers the remainder of the Euclidian division of the first one by the second one.

Comparison parameter D is for example equal to 2,000 times number W for a frequency to be obtained of 32 kHz.

If the current value in of register 218 is greater than or equal to comparison parameter D, then modulo function calculation circuit 202 is configured to send to counter 220 a control signal (En) which causes an incrementation of counter 220.

In the shown example, register 218 receives as an input the data present at node M to which is added result R. This addition is for example performed with an adder circuit 214 coupling output R of circuit 202, node M, and the input of register 218.

Calibration unit 204 is coupled, preferably connected, to node M via a dual-path switch 234. Switch 234 is for example controlled by block 110. Dual-path switch 234 is controlled so that, in the communication mode (Active mode), a parameter of the communication mode (Mactive) is available on node M and that, in the standby mode, standby mode parameter (Mcalib) is available on node M.

In the shown example, the time base which is desired to be obtained may be used as a base to generate a clock signal with a central frequency of 32 kHz which is usable for example for the BLUETOOTH® protocol. In this example, W is for example selected between values 32, 64, or 128; the output frequency of block 104 is 32 MHz; that of blocks 210 or 102 is 32.768 kHz; and the frequency issued by block 107 is 4 MHZ.

The value available on node M may further be imposed, for example by block 110, according to the transition from the standby mode to the communication mode or conversely and/or according to the number of periods of signal 2Frco after detection of the transition between the standby mode and the communication mode. For example, the value available at node M is imposed at zero from the second rising edge of signal 2Frco which follows the detection of the transition to the communication mode and this, until the first rising edge of the signal issued by block 107 (Active Clock). Then, value Mactive, and thus the value available at node M, is for example set to 2,048, which corresponds to the value of comparison parameter D, for example 256,000 for a number W of 128, divided by the ratio of the frequency of the signal issued by block 107 (4 MHZ) to the frequency which is desired to be obtained (32 kHz). When the standby mode is implemented, the value available at node M is the value Mcalib issued by calibration circuit 204.

In an example where the signal issued by block 102 is used in the standby mode, and the frequency which is desired to be obtained in fine is 32 kHz, M is set to

$$32 \times {10}^{6} \times \frac{W}{{F}_{rco}} .$$

As a result,

$$M = \frac{32 \times {10}^{6}}{32768} \times 32 k = \frac{{10}^{6}}{32} \times k = 31 , 250 k ,$$

and D=64,000 k, where k=1, 2, 4.

In an example where the accuracy of the signal issued by block 102 is better than that of block 107, then M is for example imposed at a value of 31,250.

The value available at node M is, in the shown example, directly usable by circuit 110 from as soon as it has been calculated by calibration circuit 204.

In the shown example, the values of counter 220 and that of register 218 respectively provide the integer part and the decimal part of the time base (TB) usable to generate the clock signal which is desired to be obtained. In an example, the integer part of the time base is coded over 22 bits and the decimal part is coded over 7 bits.

Those skilled in the art may use their knowledge to form a clock signal based on the generated time base. The implementation of FIG. 2 enables the values of the events of the BLUETOOTH® LOW ENERGY protocol, expressed with a 0.625-ms resolution, to be directly usable with no processing.

A same time base TB is used for the two modes, which enables not to use software computing.

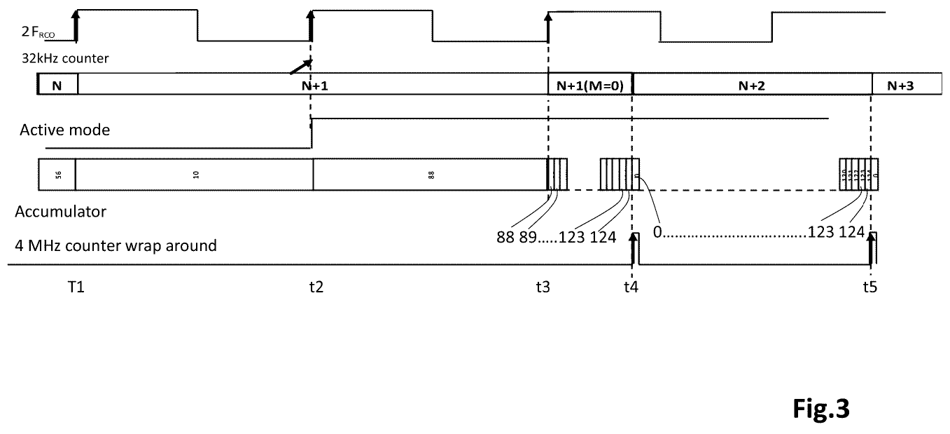

FIG. 3 shows a timing diagram of an operating mode of the radio frequency communication device of FIG. 2. More particularly, signal 2Frco is shown, as well as the signal (Active mode) representing the current mode of the device (in the low state, the standby mode is started and in the high state, the communication mode is active) as well as the values of counter 220 (32-kHz counter) and the signal issued by block 107 (4-MHz counter wrap-around) which activates the wrapping around of the accumulator (the accumulator performs a wrap-around at each rising edge). In the shown example, the seven most significant bits of the accumulator are illustrated.

Before a time t1, the value of counter 220 is at a number N, the standby mode is triggered, and the seven most significant bits of the accumulator correspond to a value, for example, of 56.

At time t1, signal 2Frco expresses a rising edge, a time t2 corresponds to a rising edge of the next period, and a time t3 corresponds to a rising edge of still a next period. From time t1 and until time t3, the value of counter 220 is at N+1. Between time t1 and a time t2 where the device transits from the standby mode to the communication mode, the seven most significant bits of the accumulator correspond to a value for example of 10.

Between time t2 and time t3, the seven most significant bits of the accumulator correspond to a value, for example, of 88.

From time t3, and until a time t4 corresponding to a first rising edge of signal linked to the wrapping around of the accumulator, the value present at node M is imposed at zero, which implies that the counter is not incremented and remains at N+1. Further, the seven most significant bits of the accumulator are incremented from 88 to 124. Value 124 corresponds to the division of the clock signal at 4 MHz issued by block 107 by the frequency of the signal which is desired to be obtained.

From time t4, which corresponds to a rising edge of the signal issued by block 107, the seven most significant bits of the accumulator switch back to 0, then are incremented up to 124 at a time t5 while counter 220 increments to N+2. The value present at node M is, from time t4, imposed at 2,048 for example.

From time t5, which corresponds to a rising edge of the signal issued by block 107, the seven most significant bits of the accumulator switch back to 0, then are incremented up to 124 while counter 220 increments to N+3 and so on until the next change of mode.

The fact of implementing a programmable wrap-around equal to the longest time interval which must be implemented in the communication protocol allows a simplification of the device. The generated events are thus synchronized with one another, which avoids collisions of events by construction. The dates of the events remain unchanged during wrap-arounds. In the example of the BLUETOOTH® LOW ENERGY protocol, the events are periodical and once the events have been installed, they may be automatically retimed unless they are deactivated. Eventually, concurrent modes may easily be implemented.

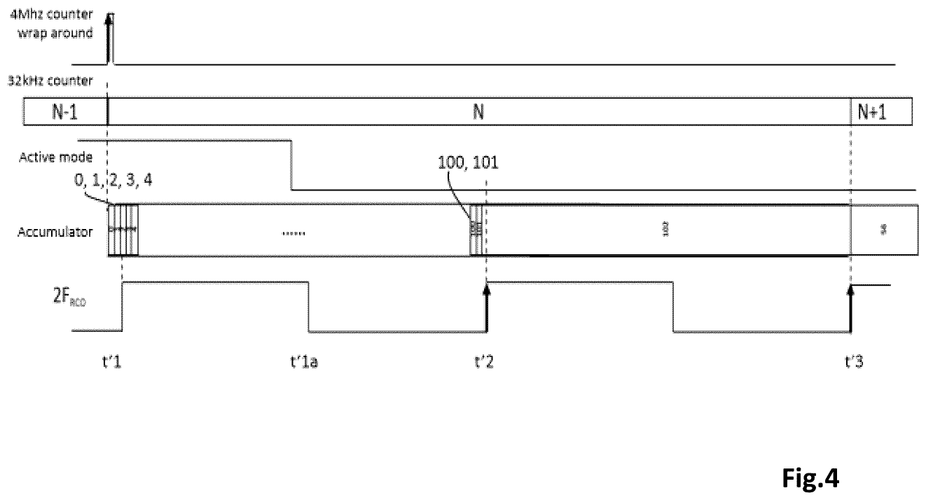

FIG. 4 shows a timing diagram of another operating mode of the radio frequency communication device of FIG. 2. The example of FIG. 4 shows the same signals and values as the example of FIG. 3 but the example shown in FIG. 4 illustrates the transition from the communication mode (Active mode) to the standby mode.

At a time t′1, which corresponds to a rising edge of the signal (4-MHz counter wrap-around) issued by block 107, counter 220 (32-kHz counter) is incremented to pass from a value N−1 to a value N and the seven most significant bits of the accumulator (Accumulator) are incremented from 0 until a time t′2.

Little after time t′1, there occurs a rising edge of signal 2Frco.

At a time t′la, subsequent to time t′1 and taking place before time t′2, the mode switches from the communication mode to the standby mode.

At time t′2, which corresponds to a rising edge of signal 2Frco following the transition from the communication mode to the standby mode, the signal issued by block 107 is replaced with signal 2Frco by the action of switch 230. The value on node M has also changed to Mcalib. At time t′2, the seven most significant bits of the accumulator for example have a value of 101.

Between time t′2 and a time t′3 which correspond to the next rising edge of signal 2Frco, the seven most significant bits of the accumulator are incremented, then remain stable at 102. The value of counter 220 remains at N until time t′3.

At time t′3, the value of counter 220 is incremented by one and the seven most significant bits of the accumulator for example have a value of 56.

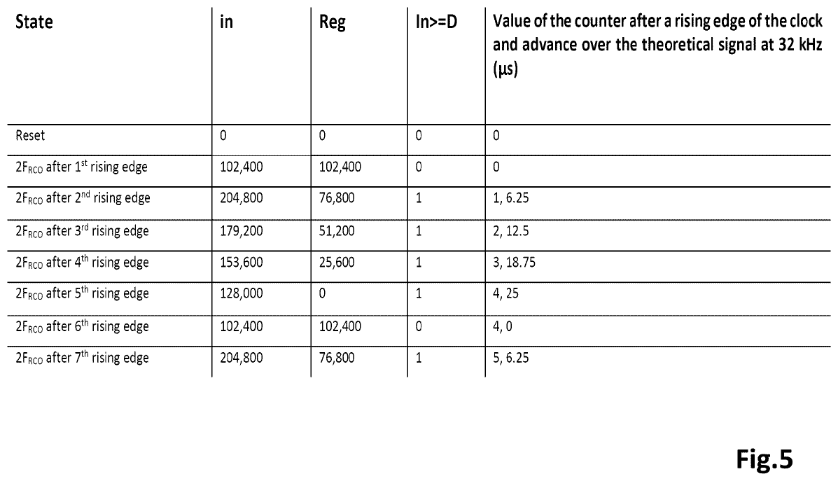

FIG. 5 shows a summary table of an operating mode of the radio frequency communication device of FIG. 2. More particularly, the table discloses the value of the counter after successive clock rising edges of signal 2Frco and the advance over the theoretical signal which is desired to be obtained in standby mode. Values in, R, and the result of calculation in ≥D are also disclosed. In the shown example, the signal which is desired to be obtained is at 32 kHz, frequency Frco is 20 kHz, and W=64, which provides M=102,400 and D=128,000.

The advance over the clock signal which is desired to be obtained (with a frequency called Fnom) is defined by the following equation:

$$Avance ( μs ) = ( D - {Reg}_{- 1} ) / D * 1 / Fnom \qquad [ Math 1 ]$$

Reg₋₁ being the value Reg of the register of the previous row.

During a reset, all values are at zero.

After the first rising edge of signal 2Frco, in is at 102,400, Reg is at 1,024,000, the result of calculation in ≥D is 0, the value of the counter is at 0 and the advance is null.

After the second rising edge of signal 2Frco, in is at 204,800, Reg is at 76,800 (=in-D), the result of calculation in ≥D is 1, the value of the counter thus is incremented to 1, and the advance is calculated at 6.25 μs.

After the third rising edge of signal 2Frco, in is at 179,200 (=102,400+76,800), Reg is at 51,200 (=179,200-128,000), the result of calculation in ≥D is 1, the value of the counter is thus incremented to 2, and the advance is calculated at 12.5 μs.

After the fourth rising edge of signal 2Frco, in is at 153,600, Reg is at 25,600 (=153,600-128,000), the result of calculation in ≥D is 1, the value of the counter is thus incremented to 3, and the advance is calculated at 18.75 μs.

After the fifth rising edge of signal 2Frco, in is at 128,000, Reg is at 0 (=128,000-128,000), the result of the calculation in ≥D is 1, the value of the counter is thus incremented to 4, and the advance is calculated at 25 μs.

After the sixth rising edge of signal 2Frco, in is at 102,400, Reg is at 102,400, the result of the calculation in ≥D is 0, the value of the counter is thus not incremented, and the advance is calculated at 0 μs.

After the seventh rising edge of signal 2Frco, in is at 204,800, Reg is at 76,800, the result of calculation in ≥D is 1, the value of the counter is thus incremented to 5, and the advance is calculated at 6,25 μs.

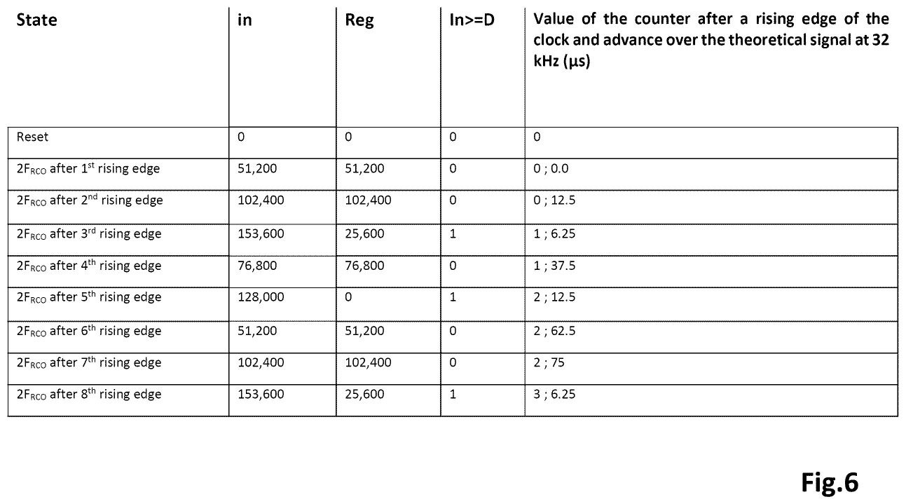

FIG. 6 shows a summary table of another operating mode of the radio frequency communication device of FIG. 2.

More particularly, the table of FIG. 6 discloses the same values as the table of FIG. 5, except that in the example disclosed in FIG. 6, the signal which is desired to be obtained is at 32 kHz, frequency Frco is 40 kHz, W=64, which provides M=51,200 and D=128,000.

During a reset, all values are at zero.

After the first rising edge of signal 2Frco, in is at 51,200, Reg is at 51,200, the result of calculation in ≥D is 0, the value of the counter is at 0, and the advance is null.

After the second rising edge of signal 2Frco, in is at 102,400, Reg is at 102,400, the result of calculation in ≥D is 0, the value of the counter is thus not incremented, and the advance is calculated at 12,5 μs.

After the third rising edge of signal 2Frco, in is at 153600, Reg is at 25600, the result of calculation in ≥D is at 1, the value of the counter is thus incremented to 1 and the advance is calculated at 6,25 μs.

After the fourth rising edge of signal 2Frco, in is at 76,800, Reg is at 76,800, the result of calculation in ≥D is 0, the value of the counter is thus not incremented, and the advance is calculated at 37,5 μs.

After the fifth rising edge of signal 2Frco, in is at 128000, Reg is at 0 (=128000-128000), the result of the calculation in ≥D is 1, the value of the counter is thus incremented to 2, and the advance is calculated at 12,5 μs.

After the sixth rising edge of signal 2Frco, in is at 51,200, Reg is at 51,200, the result of calculation in ≥D is 0, the value of the counter is thus not incremented, and the advance is calculated at 62,5 μs.

After the seventh rising edge of signal 2Frco, in is at 102,400, Reg is at 102,400, the result of calculation in ≥D is 0, the value of the counter is thus not incremented, and the advance is calculated at 75 μs.

After the eighth rising edge of signal 2Frco, in is at 153,600, Reg is at 25,600, the result of calculation in ≥D is 0, the value of the counter is thus incremented to 75, and the advance is calculated at 6,25 μs.

In the examples of FIGS. 2, 5, and 6, the transition of counter 220 occurs ahead of the clock signal which is desired to be obtained since value 2Frco is always greater than 32 kHz if Frco is in the range from 16 to 60 kHz.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove. In particular, regarding the frequencies generated by blocks 102 or 210 which may be provided to generate frequencies other than 32.768 kHz or 32 kHz. Further, the device of FIG. 2 may be used to generate other time bases to obtain clock signals different from 32 kHz.

1. A radio frequency communication device comprising: a clock signal generator configured to deliver a clock signal, based on a time base common to a communication mode and to a standby mode, from a first reference signal and a second reference signal.

2. A radio frequency communication device of claim 1, wherein the clock signal generator comprises an accumulator circuit configured to:
in the communication mode, be driven by a communication mode clock signal originating from the second reference signal, and be incremented according to a parameter of the communication mode; and
in the standby mode, be driven by a standby mode clock signal originating from the first reference signal, and be incremented according to a parameter of the standby mode.

3. A radio frequency communication device of claim 2, wherein the clock signal generator comprises a calibration circuit configured to output a number of periods of the second reference signal for a given number of periods of the first reference signal; and the output of the calibration circuit providing a possible value of the standby mode parameter.

4. A radio frequency communication device of claim 3, wherein the accumulator circuit comprises a modulo function calculation circuit and a register, the modulo function calculation circuit being configured to implement a modulo function between a current value of the register and a comparison parameter associated with the given number of periods of the first reference signal, the register being configured to:
in the communication mode, be driven by the communication mode clock signal and receive as an input the parameter of the communication mode to which is added an output result of the modulo function calculation circuit; and
in the standby mode, be driven by a standby mode clock signal proportional to the first reference signal, and receive as an input the parameter of the standby mode to which is added the output result of the modulo function calculation circuit.

5. A radio frequency communication device of claim 4, wherein the accumulator circuit comprises a counter configured to:
in the communication mode, be driven by the communication mode clock signal and by a control signal depending on a comparison between the current value of the register and the comparison parameter; and
in the standby mode, be driven by the standby mode clock signal and by the control signa.

6. A radio frequency communication device of claim 5, wherein the counter is configured to increment when the current value of the register is greater than the comparison parameter.

7. A radio frequency communication device of claim 2, wherein the accumulator comprises a wrap-around counter configured to be set back to zero when it reaches a value equal to the ratio of a frequency of the communication mode clock signal to the frequency of the clock signal to be obtained.

8. A radio frequency communication device of claim 5, wherein the counter comprises a shift register.

9. A radio frequency communication device of claim 2, wherein the value of the parameter of the communication mode or of the parameter of the standby mode is imposed.

10. A radio frequency communication device of claim 9, wherein the parameter of the communication mode is imposed at zero during a transition between the standby mode and the communication mode.

11. A radio frequency communication device of claim 4, wherein the value of the parameter of the communication mode or of the parameter of the standby mode is imposed, and wherein the parameter of the communication mode is imposed, in the communication mode, at the value of the comparison parameter divided by the ratio of the frequency of the communication mode clock signal to the frequency of the clock signal to be obtained.

12. A radio frequency communication device of claim 11, wherein the parameter of the communication mode is imposed at zero during a transition between the standby mode and the communication mode.

13. A radio frequency communication device of claim 9, wherein the parameter of the standby mode is imposed at an initial value equal to 1,000 times the number of periods of the first reference signal.

14. A radio frequency communication device of claim 2, wherein the standby mode clock signal has a frequency equal to twice the frequency of the first reference signal.

15. A radio frequency communication device of claim 1, wherein the frequency of the clock signal to be obtained is 32 kHz, the frequency of the communication mode clock signal is 4 MHz, and the frequency of the second reference signal is 32 MHz, and the frequency of the first reference signal is in the range from 16 to 60 KHz.

16. A radio frequency communication device of claim 4, wherein the frequency of the clock signal to be obtained is 32 kHz, the frequency of the communication mode clock signal is 4 MHz, and the frequency of the second reference signal is 32 MHZ, and the frequency of the first reference signal is in the range from 16 to 60 kHz; and
wherein the comparison parameter is equal to 2,000 times the number of periods of the first reference signal, and the number of periods of the first reference signal is selected between 32, 64, and 128.

17. A radio frequency communication device of claim 5, wherein the values of the counter and those of the register respectively provide the integer part and the decimal part of the time base.

18. A radio frequency communication device of claim 1, wherein the first reference signal and the second reference signal have different frequency accuracies.

19. A radio frequency communication device of claim 1, wherein the device is of BLUETOOTH®, BLUETOOTH® LOW ENERGY, or IEEE 802.15.4 type.
